(19) United States
(12) Patent Application Publication
(10) Pub. No.: US 2008/0008523 A1
(43) Pub. Date: Jan. 10, 2008

(54) Retaining Device Of A Tool Cotter For A Percussive Demolition Apparatus

(75) Inventor: Bernard Cadet, Lyon (FR)

Correspondence Address: OLIFF & BERRIDGE, PLC, P.O. BOX 320850, ALEXANDRIA, VA, 22320-4850, US

(73) Assignee: MONTABERT S.A., Saint Priest (FR)

(21) Appl. No.: 10/583,309

(22) PCT Filed: Dec. 9, 2004
(86) PCT No.: PCT/FR04/03175

§ 371 Date: Jul. 21, 2006

(30) Foreign Application Priority Data
Dec. 15, 2003 (FR) 0314668

(51) Int. Cl. B25D 17/08

(52) U.S. Cl. 403/319

(57) ABSTRACT

The tool mounted in a body of an apparatus is retained by a cotter engaging inside a notch of the tool, the cotter being engaged in a borehole of the body. The area of the body containing this borehole for engagement of the cotter is equipped with a covering ferrule. This ferrule is provided for occupying a first position in which it at least partially occludes the borehole and a second position in which the borehole is cleared for enabling the cotter to be inserted or removed.

The subject of the present invention is a tool cotter retaining device for a percussive demolition apparatus.

In percussive demolition apparatus, a shockwave is generated by the impact of a piston driven with alternating motions on a tool. This tool makes it possible to transmit the shockwave to the materials to be demolished.

Since the tool is a wearing part of the percussive demolition device, its replacement is a routine operation carried out by the operator. It is therefore appropriate to have a tool retaining device that holds the latter during work and also makes easy removal possible.

The most widely used device comprises a cotter perpendicular to the axis of the tool and engaged in a groove made in the tool, this cotter being housed in the body of the percussive demolition device.

It is therefore appropriate, for practical reasons, that the cotter for retaining the tool is held in position in its housing when the device is working and that it is easy to extract for changing the tool.

Various known solutions are possible.

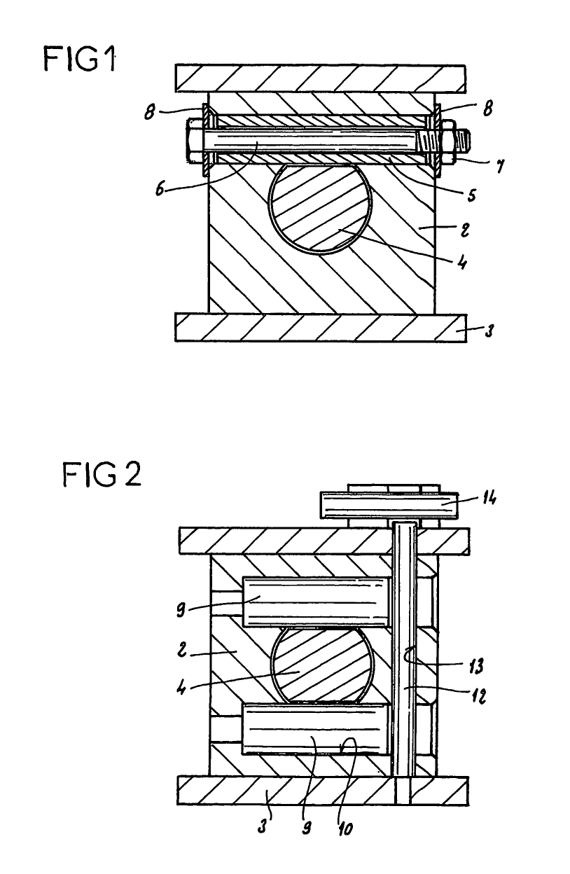

FIG. 1 represents a first solution. In FIG. 1, the body of the apparatus is indicated by reference number 2, this body being mounted between two end-plates 3 forming a casing, a tool 4 being mounted in a bore of the body 2. The tool is retained by a tubular cotter 5, inside which a threaded shaft 6 immobilized by a nut 7 is engaged, with interposition of washers 8 between the body and the head of the shaft, on the one hand, and the nut 7, on the other hand.

FIG. 2 represents another embodiment in which the same elements are indicated by the same reference numbers as hereinabove. In this case, the tool 4 is retained by two cotters 9 engaged in two bores 10, the two cotters being immobilized in their position of use by a transverse pin 12 mounted in a housing 13 placed inside the body 2, the pin 12 itself being immobilized by a pin 14 situated outside the body.

These devices are relatively complicated and are partly outside the body and are exposed to the shocks while the device is working.

The technical problem at the base of the invention is to provide a cotter retaining device that has a simple structure, operates effectively and can be adapted to low power apparatus, having a generally cylindrical shape.

Accordingly, the device to which the invention relates is of the type designed for a percussive demolition apparatus, wherein the tool mounted in a body of the apparatus is retained by a transverse cotter engaged in a notch of the tool, the cotter being engaged in a bore of the body.

According to the invention, the zone of the body comprising the bore for the engagement of the cotter is fitted with a covering ferrule, this ferrule being arranged to occupy a first position in which it at least partially closes off the bore and a second position in which the bore is uncovered, to allow the cotter to be inserted or removed.

The body of the apparatus is therefore covered by a thin ferrule which, depending on its position, may or may not close off the opening for inserting the cotter. The transition from the position covering the opening to the position in which the latter is uncovered may be achieved by rotation or by translation along the body.

According to a feature of the invention, the ferrule is made of a material with a high elastic limit, and advantageously of spring steel.

According to another feature of the invention, the body of the apparatus comprises a peripheral groove, into which the bore of the cotter opens, and which serves for the positioning and guidance of the ferrule on the body. The peripheral groove made in the body of the apparatus provides, on the one hand, the guidance in rotation of the ferrule about the body, and prevents the ferrule from protruding from the body, thus ensuring a perfect protection of the latter, particularly against the shocks that the apparatus may sustain.

If the ferrule can be moved in translation on the body, the groove performs the function of only retaining the ferrule in the position of immobilizing the cotter.

According to another possibility, the body of the apparatus comprises raised elements, such as ribs or pins serving to guide the ferrule.

According to one embodiment of the invention, the ferrule is of cylindrical shape and consists of a cylinder closed on itself in which an opening is made with a diameter at least equal to the diameter of the bore of the body designed for the cotter to pass through.

According to a variant embodiment of this device, the ferrule is of generally cylindrical shape and consists of a split ring. This ring may, depending on the embodiments, pivot on the body or be moved in translation on the latter.

Advantageously, and in order to prevent any risk of accidental movement of the ferrule likely to allow the cotter to be uncovered, the ferrule comprises a finger, turned on its inner face, designed to engage in a recess of the body, to lock the ferrule in position covering the bore of the body designed for the cotter to pass through.

In any case, the invention will be well understood with the aid of the following description, with reference to the appended schematic drawing representing, as nonlimiting examples, several embodiments of this device.

FIGS. 1 and 2 are two views in cross section of two devices illustrating the prior art.

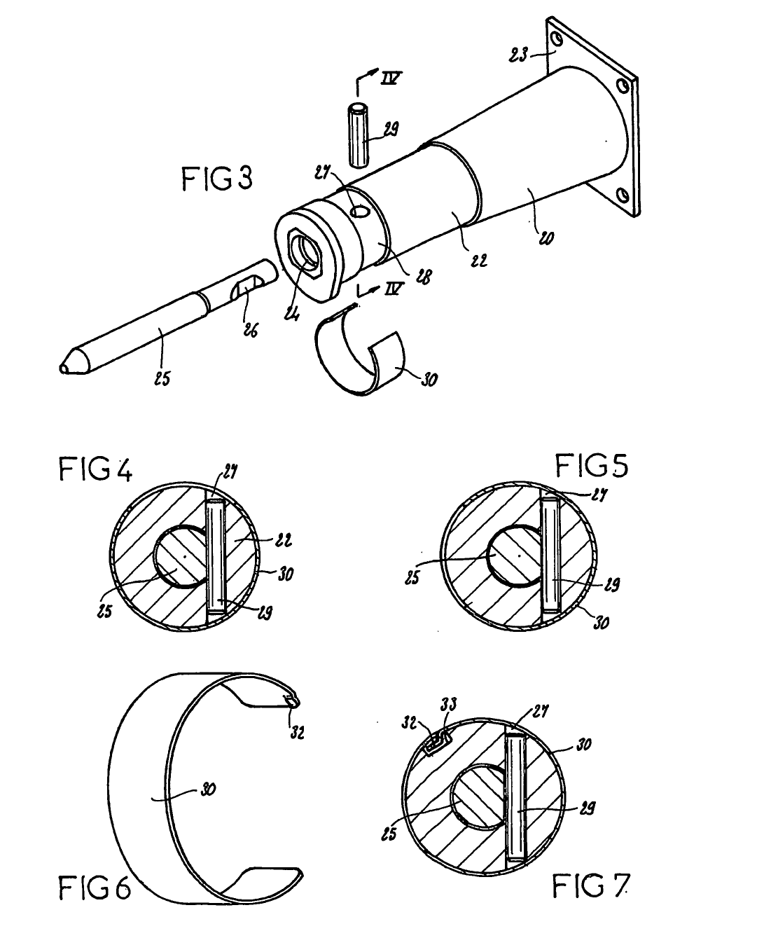

FIG. 3 is an exploded view in perspective of a percussive demolition apparatus fitted with the device according to the invention.

FIGS. 4 and 5 are two views in cross section and on an enlarged scale of this device along the line IV-IV of FIG. 3, respectively in the uncovered position and in the locked position of the cotter.

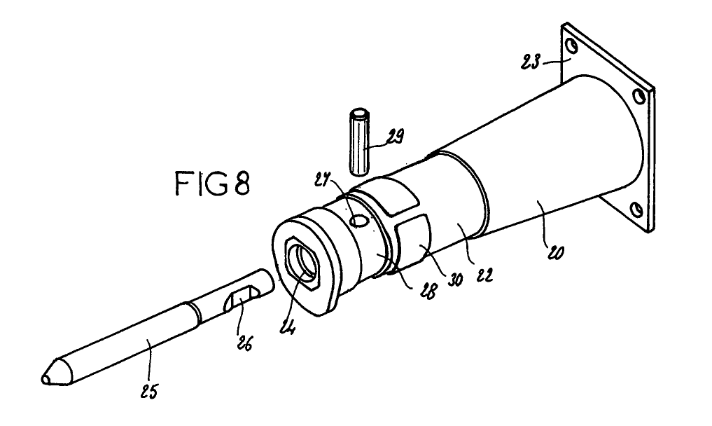

FIG. 6 is a view in perspective on an enlarged scale of another ferrule.

FIG. 7 is a view in cross section, similar to FIG. 5, of an apparatus fitted with the ferrule of FIG. 6.

FIG. 8 is a view in perspective of an apparatus fitted with a ferrule that can be moved in translation.

FIG. 3 represents an apparatus 20 comprising a body 22 of substantially cylindrical cross section terminating at one of its ends in a plate 23 for attachment to a support. In the end of the body opposite to that fitted with the plate 23, a bore 24 opens, designed for the passage of a tool 25 comprising, in its rear zone, a notch 26. In the body 22 a transverse bore 27, offset relative to the axis of the body 22, is arranged, this bore emerging in a peripheral groove 28 comprised in the body. The bore 27 serves for the engagement of a cotter 29 for retaining the tool, by the engagement of the cotter in the notch 26 of the tool 25.

The groove 28 is designed for the mounting of a ferrule 30, of a width substantially matching that of the groove, made of a material with a high elastic limit, such as spring steel. The length of the ferrule is less than the perimeter of the body, in order to arrange between the two ends of the ferrule a slot that is wider than the diameter of the bore 27 receiving the cotter 29.

In practice, when the cotter is inserted, the ferrule is pivoted into the position shown in FIG. 4, uncovering the bore 27, and allowing the cotter to be inserted or removed. On the other hand, while the apparatus is working, the ferrule is pivoted into the position of FIG. 5 to close off the bore 27.

FIG. 6 represents a ferrule 30 similar to that previously described, one end of which is furnished with a finger 32 protruding on its inner face, this finger 32 being designed to engage in a recess 33 made in the outer wall of the body of the apparatus in the closed position of the ferrule, as shown in FIG. 7.

In the embodiment shown in FIG. 8, the ferrule 30 consists of a split ring, which can be moved in translation on the body 22 to uncover, as shown in the drawing, the bore 27 designed to receive a cotter 29. In the working conditions of the apparatus, the ferrule 30 is housed in the groove 28.

It should be specified that the term “body” that has been used previously in the description must be taken in the broad sense, and may just as well relate to the body of the apparatus or to a casing surrounding the body, insofar as the apparatus is more complex and comprises a body designed for the guidance of the tool and the hydraulic actuation of the latter, and an outer casing serving as a support for the assembly.

As emerges from the foregoing, the invention provides a great enhancement to the prior art, by providing a device of simple structure, perfectly incorporated into the apparatus and not risking being damaged during the operation of the latter, while having a moderate cost price.

It goes without saying that the invention is not limited only to the embodiments of this device that are described hereinabove as examples; on the contrary, it covers all the variants thereof.

1. A tool cotter retaining device for a percussive demolition apparatus, in which the tool mounted in a body of the apparatus is retained by a transverse cotter engaged in a notch of the tool, the cotter being engaged in a bore of the body, wherein the zone of the body comprising the bore for the engagement of the cotter is fitted with a covering ferrule, this ferrule being arranged to occupy a first position in which it at least partially closes off the bore and a second position in which the bore is uncovered, to allow the cotter to be inserted or removed.

2. The device as claimed in claim 1, wherein the ferrule is made of a material with a high elastic limit.

3. The device as claimed in claim 1, wherein the ferrule is made of spring steel.

4. The device as claimed in claim 1, wherein the body of the apparatus comprises a peripheral groove, into which the bore of the cotter opens, and which serves for the positioning and guidance of the ferrule on the body.

5. The device as claimed in claim 1, wherein the body of the apparatus comprises raised elements, such as ribs or pins serving to guide the ferrule.

6. The device as claimed in claim 1, wherein the ferrule is of cylindrical shape and consists of a cylinder closed on itself in which an opening is made with a diameter at least equal to the diameter of the bore of the body designed for the cotter to pass through.

7. The device as claimed in claim 1, wherein the ferrule is of generally cylindrical shape and consists of a split ring.

8. The device as claimed in claim 7, wherein the ferrule comprises a finger, turned on its inner face, designed to engage in a recess of the body, to lock the ferrule in position covering the bore of the body designed for the cotter to pass through.
